(19) United States
(12) Patent Application Publication
(10) Pub. No.: US 2020/0094726 A1
(43) Pub. Date: Mar. 26, 2020

(54) AUTOMOTIVE VEHICLE DELIVERY APPARATUS AND METHOD

(71) Applicant: MCCLUSKEY CHEVROLET, INC., Cincinnati, OH (US)

(72) Inventors: Keith P. McCluskey, Cincinnati, OH (US); Harold D. Stewart, JR., Obetz, OH (US); David Haynes, Cincinnati, OH (US)

(21) Appl. No.: 16/575,956

(22) Filed: Sep. 19, 2019

Related U.S. Application Data
(60) Provisional application No. 62/734,085, filed on Sep. 20, 2018.

(51) Int. Cl. B60P 3/07; B60G 17/00; B60P 1/43; B60Q 3/30; B60Q 3/40; B60Q 3/74; B62D 33/04; B62D 63/06; G06Q 10/08

(52) U.S. Cl. CPC B60P 3/07; B60G 17/00; B60P 1/43; B60Q 3/30; B60G 2500/324; B60Q 3/74; B62D 33/046; B62D 63/06; G06Q 10/083; B60Q 3/40

(57) ABSTRACT

An automotive vehicle delivery apparatus includes a traveling showroom structure with sidewalls and a rearwall that enclose an interior vehicle transport space and a substantial majority of which are made up of see-through panes. On board loading rails enable an automotive vehicle to be driven into the interior transport space and doors along the sidewalls enable the automotive vehicle driver door to be opened when the automotive vehicle is within the interior transport space.

### TECHNICAL FIELD

The present invention relates generally to delivery of purchased automotive vehicles, more particularly, to a delivery apparatus and method for such purpose.

### BACKGROUND

The market for used vehicles creates many opportunities. With the continued increase of consumer interest in online shopping, used vehicle sales services in which a consumer purchases a vehicle online and the vehicle is delivered to a purchaser specified location have become more prevalent. Typically, the vehicle is loaded onto the bed of a truck and unloaded at the delivery site in a manner similar to vehicle handling by flatbed tow trucks.

Vehicle transport trailers that enclose the vehicle exist. Loading and unloading the vehicle from such trailers can be cumbersome. One example of a loading/unloading system for vehicles is described in U.S. Pat. No. 7,478,984, which uses a trolley with vehicle support rails, where the trolley is movable into and out of the trailer using a winch system. The vehicle can be driven onto the trolley rails when the trolley is extended from the rear of the trailer. The vehicle wheels are then strapped to the trolley rails, and the trolley is winched into the trailer to secure the vehicle for transport. This system functions for its intended purpose, but is difficult to use, expensive and takes up seven-hundred pounds of the available payload capability of the transport apparatus.

It would be desirable to provide a vehicle delivery system that provides a higher end consumer experience while at the same time protecting the vehicle (used or new) being purchased by enclosing the vehicle. It would also be desirable to provide a system that enables the vehicle to be driven directly into the trailer and secured with ease.

### SUMMARY

A weatherproof exposed view delivery truck or trailer having a vehicle transport space that is configured as a see-through traveling showroom.

In one embodiment, a heavy duty truck cab and chassis is configured with a chassis mounted showroom. The chassis mounted showroom includes a main bed with upright spaced aluminum sidewall supports, where a majority of each sidewall is formed by see-through panes, such as Lexan MR10 acrylic, that enable viewing of a transported vehicle within the weatherproof traveling showroom, with the transported vehicle secured to the main bed per DOT standards.

The main bed is supported on the chassis and the chassis is supported by wheels/tires.

The see-through panes of each sidewall may be formed of non-moving windows with one or more panes and one or more movable doors with one or more panes.

At least one sidewall, and preferably both sidewalls, include one or more see-through pane doors positioned to permit free opening of the front doors of a vehicle loaded for transport and to provide access to all four of the wheels/tires of the transported vehicle for purpose of securing the vehicle per DOT standards.

### BRIEF DESCRIPTION OF THE DRAWINGS

FIG. 1 is a front perspective view of one embodiment of a delivery truck including a traveling showroom for use in automotive vehicle transport;

FIG. 2 is a schematic side elevation view of the chassis mounted traveling showroom;

FIG. 3 is a schematic top plan view of the traveling showroom (without the top skin covering shown);

FIG. 4 is a schematic rear elevation view of the traveling showroom (without chassis wheels/tires shown);

FIG. 5 is an enlarged schematic side elevation of a rear portion of the chassis mounted traveling showroom; and

FIG. 6 is a section view depicting mounting of the see-through panes to the tubular supports of the traveling showroom.

### DETAILED DESCRIPTION

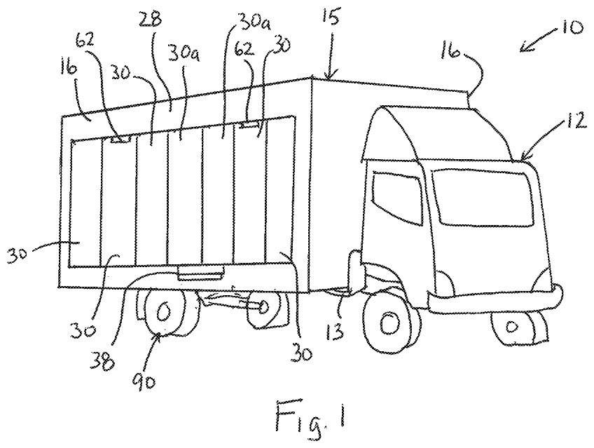

Referring to FIGS. 1-6, a weatherproof exposed view delivery apparatus 10 with as a glass-sided traveling showroom is described. A heavy duty truck cab 12 with a chassis 13 extending rearwardly therefrom is configured with a traveling showroom 15 thereon. The traveling showroom 15 is fixed to the chassis frame and includes a main bed 14 with upright sidewalls 16 formed on each longitudinal side of the main bed. Each sidewall has set of sidewall supports that may, for example, be of tubular aluminum configuration, with longitudinal end tubular supports 18a being 3″×6″ or 2″×4″ tubulars, and intermediate tubular supports 18b being 2″×3″ or 2″×3″ tubulars. However, other variations are possible. Each sidewall may also include a longitudinally extending upper tubular support 21 and an intermediate 20 tubular support, such that the combination of supports 18a, 18b, 20 and 21 define a plurality of upper framed spaces 24 and the combination of supports 18a, 18b, 20 and the main bed 14 define a plurality of lower framed spaces 26. A metal skin 28 may be applied to cover the upper framed spaces 24, as well as to provide a top wall over the interior transport space of the traveling showroom. However, a majority of each sidewall 16 is formed by see-through panes 30 mounted in the lower framed spaces 26. The see-through panes may be, for example, Lexan MR10 acrylic panes or some other suitable panes, which enable viewing a vehicle within the weatherproof exposed view showroom of the truck. In practice, a vehicle to be delivered will be loaded within the showroom and secured per DOT standards.

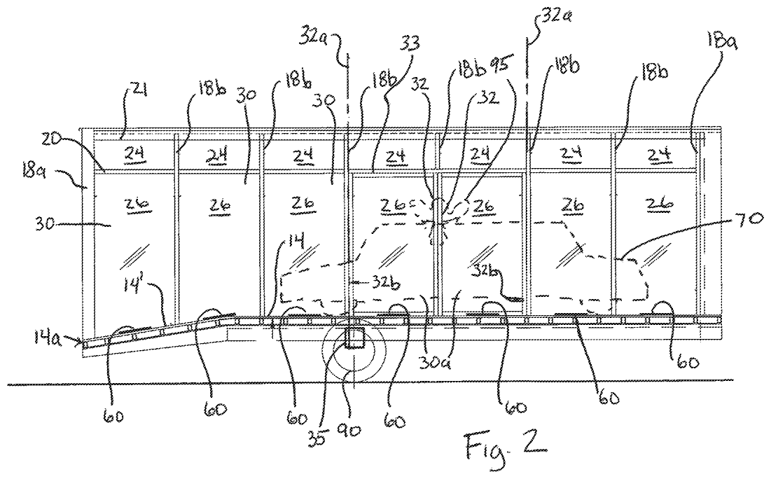

The main bed is supported on the chassis, which is supported by a set of wheels/tires 90. A major portion of the main bed is substantially horizontal and a minor rear portion 14′ of the main bed angles downwardly. The chassis, and thus the main bed, is supported on the set of rear wheels/tires by an air ride drop rear suspension (shown schematically as 35 in FIG. 2) that is movable between a raised transport position and a lowered load/unload position. In the lowered load/unload position of the air ride drop rear suspension, a height of a rear end 14a of the main bed is lowered by at least six inches as compared to the height of the rear end when the air ride drop rear suspension is in the raised transport position.

The see-through panes 30 of each sidewall may, for example, be at least sixty inches high (e.g., at least seventy inches high). Here, where seven panes 30 are provided for each sidewall, and the sidewall has a length of approximately three-hundred inches, a lateral width of each pane (extending along the sidewall length) may be between about forty inches and about forty-five inches. Thus, at least sixty-five percent of the portion of each sidewall (such as at least seventy-five percent and in some cases at least eighty percent) from the upper surface of the main bed upward may be formed by the one or more see-through panes to provide the traveling showroom appearance of the structure.

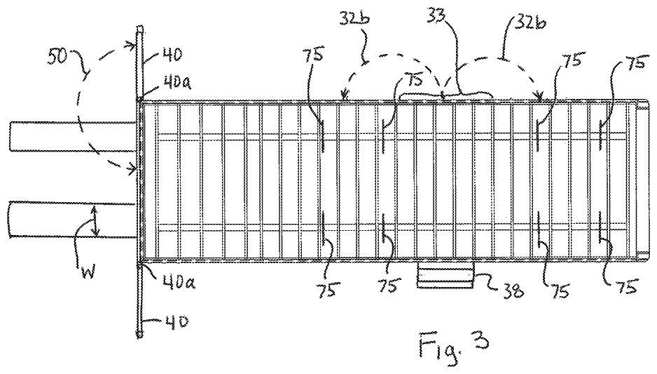

A majority of the panes 30 may be formed as non-moving panes. In addition to non-moving panes, in the illustrated embodiment, each sidewall also includes multiple panes (here two on each side) 30a that are formed as pivotable doors 32. The upright pivot axis 32a at the hinge side 32b of each movable door 32 is spaced from the forward end and rearward end of each sidewall (e.g., the doors are located along a mid-region of each sidewall). In this regard, the doors are positioned and located such that a side access opening 33 (delimited by the combined outer perimeter of the two doors 32 in FIG. 2 and also shown in FIG. 3), which is accessible when the doors 32 are opened, is adjacent to the front doors of an automotive vehicle 70 loaded within the interior transport space allowing the vehicle doors to be opened (e.g., part of the vehicle door may protruded outward from the access opening 33 in order to permit an operator to enter and exit the vehicle when it is loaded). In addition, the access opening 33 is preferably sized with a lateral width that is designed to enable sufficient access to both the front and rear wheels/tires of the loaded vehicle so that all wheels/tires can be strapped down by a person standing on the ground alongside the access opening, as will be described in more detail below. Here, each door 32 may pivot substantially one-hundred eight degrees between its closed position and its open position, as suggested by the arrows 32b shown in FIG. 3. In other embodiments, the doors 32 could be sliding doors that slide rather than pivot (e.g., with the doors mounted on a slide rail system slightly to the interior or exterior of the rest of the sidewall).

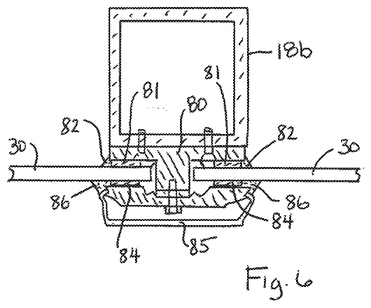

With respect to the mounting of the see-through panes, as seen in FIG. 6, the panes 30 may be fixedly mounted to the aluminum tubulars (e.g. 18b) using a metal mount shoe 80 that is screwed to the outer side of the tubular. A double-faced glazing tape 81 is applied to the outer side of the mount shoe surface, along with adjacent silicone sealant 82. The panes 30 are pressed against the tape and silicone by a pressure plate 83 that clamps the panes in place by screwing into the mount shoe. Double-faced glazing tape 84 is also located between the outer surface of the panes 30 and the inwardly facing side of the pressure plate 83. A snap on cover 85 (e.g., of aluminum or plastic) mounts to the pressure plate by engaging with grooves on the pressure plate 83. A perimeter bead of silicone 86 is also applied to aid in securing the cover in place.

A retractable step system (e.g., 38 shown retracted in FIG. 1 and extended in FIG. 3) may be associated with the access opening 33 in each sidewall to enable an operator to readily enter and exit the interior transport space of the traveling showroom. The step system may be manually retractable/extendable or may be powered (e.g., such as manual or electric motor home style steps).

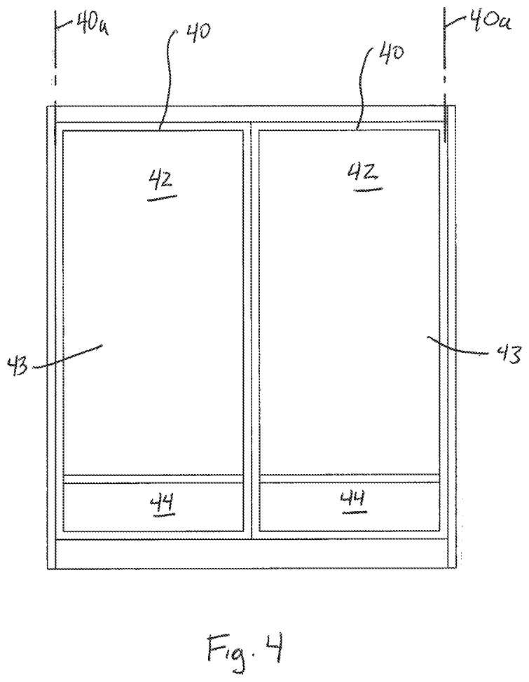

FIG. 4 shows a rear view showing the rear wall formed by two doors 40, each of which is pivotable about an upright axis 40a for movement of the doors between open and closed positioned for loading and unloading of vehicles through the rear access opening. Upper framed spaces 42 of the doors receive see-through panes 43, and lower framed spaces 44 may covered with metal skins. Thus, the rear doors are also see-through for viewing of a loaded vehicle.

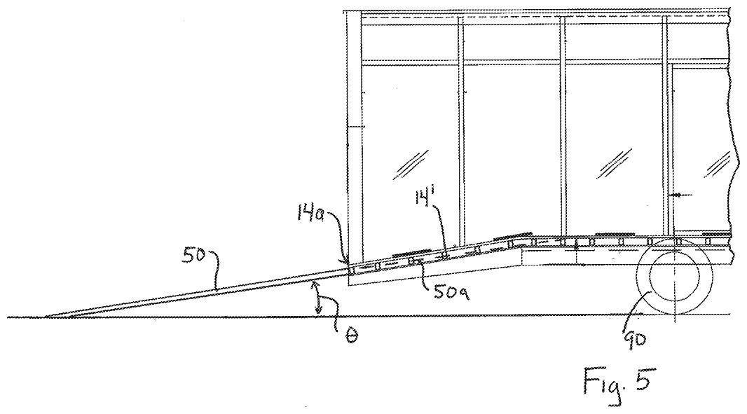

Spaced apart loading rails 50 are loaded within at least one storage space below an upper surface of the main bed 14. The loading rails 50 are movable out of the storage space into vehicle load/unload positions extending rearwardly from the rear end of the main bed and onto a ground surface, as reflected in FIGS. 3 and 5. A width W of each loading rail 50 may, for example, be twenty-four inches or more to accommodate numerous vehicle widths and tire widths of the vehicles to be loaded/unloaded from the transport space within the showroom structure. The storage position of each rail is represented by dashed line 50a in FIG. 5. The loading rails may have respective forward ends that latch onto bars at the rear end of the main bed for the purpose of retaining the loading rails in the load/unload position. A ramp load angle θ provided by the loading rails is preferably no more than fifteen degrees (such as no more than ten degrees) measured relative to horizontal when the air ride drop rear suspension is in the lowered load/unload position.

The main bed includes tie down rods/bars 75 (the positions of which are shown schematically in FIG. 3) positioned to permit tie down straps to be placed over the wheels of the loaded vehicle and tightened (against the tie down rods/bars) in order to meet DOT standards for safe transportation of the loaded vehicle.

Lighting may be provided within the interior transport space of the showroom structure to enhance the appearance of the loaded vehicle. For example, floor-mounted lighting units 60 located along the bottom interior of each sidewall of the showroom structure will provide up-lighting along the sides of the loaded vehicle. Moreover, one or more overhead lights 62 can be provided. Here, each lighting unit 60 is centered on the lateral width of one of the panes 30. The side lighting units 60 may, for example, be LED white light units angled at forty-five degrees from horizontal toward the interior transport space and loaded vehicle. The overhead lighting may be blue LED ceiling cove lighting. This particular lighting combination creates a dynamic evening/nighttime look for the traveling showroom structure to generate customer interest.

The subject traveling showroom structure enables a vehicle delivery method in which the vehicle is loaded into the interior transport space when the see-through rear access doors 40 are opened, the air ride drop rear suspension is lowered and the loading rails 50 are in the load/unload position. The automotive vehicle to be delivered is, preferably, driven in reverse into the interior transport space of the traveling showroom structure so that the front end of the loaded vehicle is facing rearward for enhanced viewing (from both the see-through sides and see-through rear doors) during transport. Prior to loading, the side doors 32 are opened so that the driver can exit the loaded vehicle and so that access to the wheels/tires of the loaded vehicle is facilitated. The access opening 33 adjacent the driver side of the loaded vehicle enables the vehicle driver to freely open the driver side door and exit the vehicle when the vehicle is properly loaded and positioned. The access openings 33, provided by the opened doors 32 (on both sides of the showroom structure), also enable the operator to freely access the wheels/tires of the loaded vehicle for strap tie down purposes. Where the traveling showroom structure includes the retractable steps mentioned above, the steps facilitate the operator access up to the main bed and down from the main bed. Once the loaded vehicle is secured in place, the rails 50 are moved into their storage positions, all showroom structure doors (side and rear) are closed and locked/latched and the air ride drop rear suspension is raised for transport. During transport and/or upon arrival of the vehicle to the customer delivery site, the loaded vehicle is illuminated by the above-mentioned lighting to enhance the vehicle appearance. Upon arrival at the customer site, the air ride drop rear suspension is lowered, the see-through rear doors are opened and the rails are moved into load/unload positions. The operator then opens the side doors 32 as needed to remove the tie down straps and enter the interior transport space. The operator then enters the loaded vehicle and drives the loaded vehicle down out of the traveling showroom structure for transfer to the purchasing customer. A set of weatherproof outdoor speakers may also be mounted in the header of the traveling showroom to enable playing music during the delivery and unloading process.

Moreover, the transported vehicle may be adorned with a large bow 95 (FIG. 2) on its top to generate excitement on the part of the customer as well as persons viewing the transported vehicle while it is being delivered. In this regard, the metal skin 28 (FIG. 1) on the sides and/or other portions of the traveling showroom structure may include advertising/marketing information for the seller of the vehicle (e.g., a specific used car dealer), which helps generate additional leads for the seller.

Notably, the traveling showroom structure provides protection for the vehicle from the elements during delivery, while at the same time enabling a customer to immediately view the vehicle as it arrives and enjoy, along with his/her neighbors, a very unique and memorable delivery experience.

The general delivery process can also be described as follows: (a) driving an automotive vehicle up into the interior transport space along the first and second loading rails while the first and second loading rails are in load/unload positions, the drop suspension is in its lowered load/unload position, the first and second see-through rear doors are open, and the first side access opening is in its open condition and the second side access opening is in its open condition; (b) exiting the automotive vehicle via a driver side door of the vehicle; (c) securing all four tires/wheels of the automotive vehicle to the main bed through the first side access opening and the second side access opening; (d) placing the first and second rails into the at least one storage space; (e) placing the first side access opening in its closed condition, placing the second side access opening in its closed condition, and closing the first and second see-through rear doors; (f) placing the drop suspension into its raised transport position; (g) driving the delivery truck to a purchasing customer site; (h) placing the drop suspension in its lowered load/unload position; (i) opening the first and second see-through rear doors, placing the first side access opening in its open condition and placing the second side access opening in its open condition; (j) moving the first and second loading rails into their respective load/unload positions; (k) unsecuring the automotive vehicle from the main bed through the first and second side access openings; (l) entering the automotive vehicle via the driver side door; and (m) driving the automotive vehicle down out of the traveling showroom structure along the first and second loading rails.

It is to be clearly understood that the above description is intended by way of illustration and example only, is not intended to be taken by way of limitation, and that other changes and modifications are possible. For example, while the traveling showroom structure is described as being mounted on a truck chassis, in an alternative embodiment the traveling showroom structure could be mounted on a towable trailer frame.

What is claimed is:

1. A weatherproof exposed view delivery apparatus adapted for vehicle delivery, comprising:
a main bed;
a plurality of walls defining an interior transport space above the main bed, the plurality of walls including:
spaced apart first and second sidewalls extending upward from the main bed, wherein a majority of each of the first and second sidewalls is formed by multiple see-through panes;
a top wall extending from the first sidewall to the second sidewall; and
a rear wall extending from the first sidewall to the second sidewall and including at least one door.

2. The apparatus of claim 1, wherein the rear wall is also formed by multiple see-through panes to provide viewing of the interior space through each of the first sidewall, the second sidewall and the rear wall.

3. The apparatus of claim 2, wherein:
each sidewall has a length and a height defining a sidewall area, wherein the height is measured from an upper surface of the main bed upward to a top of the sidewall, and wherein at least sixty-five percent of the sidewall area is formed by see-through panes;
the rear wall has a rear width and a rear height defining a rear wall area, wherein the rear height is measured from the upper surface of the main bed upward to a top of the rear wall, and wherein at least sixty-five percent of the rear wall area is formed by see-through panes.

4. The apparatus of claim 2, wherein:
the first sidewall includes at least one first door movable between a closed position and an open position relative to a first side access opening of the first sidewall, in the open position the first side access opening provides access to the interior transport space;
the second sidewall includes at least one second door moveable between a closed position and an open position relative to a second access opening of the second sidewall, in the open position the second access opening provides access to the interior transport space.

5. The apparatus of claim 4, wherein the first access opening is located to enable opening a door of a vehicle positioned within the interior transport space, and the second access opening is located to enable opening of a door of a vehicle positioned within the interior transport space.

6. The apparatus of claim 5, wherein a first step system is provided in alignment with the first side access opening and is movable between a raised and inward transport position and a lowered and outward access position, wherein a second step system is provided in alignment with the second side access opening and is movable between a raised and inward transport position and a lowered and outward access position.

7. The apparatus of claim 1, wherein a major portion of the main bed is substantially horizontal and a minor rear portion of the main bed angles downwardly.

8. The apparatus of claim 6, further comprising a set of rear wheels/tires supporting the main bed, wherein the main bed is supported on the set of rear wheels/tires by a drop suspension movable between a raised transport position and a lowered load/unload position, wherein, in the lowered load/unload position, a height of a rear end of the main bed is lowered by at least six inches as compared to the height of the rear end when the drop suspension is in the raised transport position.

9. The apparatus of claim 8, further comprising first and second loading rails loaded within at least one storage space below an upper surface of the main bed, wherein the first and second loading rails are movable out of the storage space into load/unload positions extending rearwardly from the rear end of the main bed and onto a ground surface.

10. The apparatus of claim 9, wherein a ramp load angle provided by the first and second loading rails, when the drop suspension is in the lowered load/unload position, is no more than fifteen degrees measured relative to horizontal.

11. The apparatus of claim 10, wherein the ramp load angle is no more than ten degrees.

12. The apparatus of claim 1, wherein the interior transport space includes lighting configured to enhance vehicle appearance, including one or both of:
(i) white LED floor lighting along each of the first sidewall and the second sidewall and angled toward the interior transport space;
(ii) blue LED ceiling lighting.

13. The apparatus of claim 1, wherein the main bed and the plurality of walls are mounted on a chassis extending from a truck cab.

14. The apparatus of claim 1, wherein the main bed and the plurality of walls are formed on a towable trailer.

15. A method of delivering an automotive vehicle to a purchasing customer site, the method comprising:
(a) utilizing a delivery truck with a traveling showroom structure that includes:
a main bed, a plurality of walls defining an interior transport space above the main trailer bed, the plurality of walls including: (i) spaced apart first and second sidewalls extending upward from the main bed, wherein a majority of each of the first and second sidewalls is formed by multiple see-through panes, (ii) a top wall extending from the first sidewall to the second sidewall, and (iii) a rear wall extending from the first sidewall to the second sidewall, the rear wall formed at least in part by first and second moveable see-through rear doors, such that the interior transport space is viewable through each of the first sidewall, the second sidewall and the rear wall;
wherein the first sidewall includes a first side access opening and at least one first door that is movable to provide a closed condition of the first side access opening and an open condition of the first side access opening, in the open condition, the first side access opening provides access to the interior transport space;
wherein the second sidewall includes a second side access opening and at least one second door moveable to provide a closed condition of the second side access opening and an open condition of the second side access opening, in the open condition, the second side access opening provides access to the interior transport space;
a set of rear wheels/tires supporting the main bed, wherein the main bed is supported on the set of rear wheels/tires by a drop suspension movable between a raised transport position and a lowered load/unload position, wherein, in the lowered load/unload position, a height of a rear end of the main bed is lowered by at least six inches as compared to the height of the rear end when the drop suspension is in the raised transport position;
first and second loading rails loaded within at least one storage space below an upper surface of the main bed, wherein the first and second loading rails are movable out of the storage space into load/unload positions extending rearwardly from the rear end of the main bed and onto a ground surface;
(b) driving an automotive vehicle up into the interior transport space along the first and second loading rails while the first and second loading rails are in load/unload positions, the drop suspension is in its lowered load/unload position, the first and second see-through rear doors are open, and the first side access opening is in its open condition and the second side access opening is in its open condition;
(c) exiting the automotive vehicle via a driver side door of the vehicle;
(d) securing all four tires/wheels of the automotive vehicle to the main bed through the first side access opening and the second side access opening;
(e) placing the first and second rails into the at least one storage space;
(f) placing the first side access opening in its closed condition, placing the second side access opening in its closed condition, and closing the first and second see-through rear doors;
(g) placing the drop suspension into its raised transport position;
(h) driving the delivery truck to a purchasing customer site;
(i) placing the drop suspension in its lowered load/unload position;
(j) opening the first and second see-through rear doors, placing the first side access opening in its open condition and placing the second side access opening in its open condition;
(k) moving the first and second loading rails into their respective load/unload positions;
(l) unsecuring the automotive vehicle from the main bed through the first and second side access openings:
(m) entering the automotive vehicle via the driver side door;
(n) driving the automotive vehicle down out of the traveling showroom structure along the first and second loading rails.
